(19) United States
(12) Patent Application Publication
(10) Pub. No.: US 2019/0315286 A1
(43) Pub. Date: Oct. 17, 2019

(54) BIKE RETAINING DEVICE

(71) Applicant: MONT BLANC INDUSTRI AB, DALSJOFORS (SE)

(72) Inventor: LENNART HALLENBERT, VARGARDA (SE)

(21) Appl. No.: 16/471,673

(22) PCT Filed: Dec. 20, 2017
(86) PCT No.: PCT/EP2017/083931

§ 371 Date: Jun. 20, 2019

(30) Foreign Application Priority Data
Dec. 21, 2016 (EP) 16205990.1

(51) Int. Cl. B60R 9/10; B62H 3/08

(52) U.S. Cl. CPC B60R 9/10; B62H 3/08

(57) ABSTRACT

A bike retaining device includes an elongated arm having a longitudinal extension, a first portion and a second portion projecting laterally away from the elongated arm, and a hook connected to the first portion, the hook having a first shank and a second shank. In a first configuration the first shank is arranged such that a distance between the first and second portions is at least partially covered by the first shank. The hook is movable from the first configuration to a second configuration. In the second configuration the second shank is arranged such that the distance between the first and second portion is at least partially covered by the second shank, whereby a space is defined by the first portion, the second portion and the second shank for securing the frame portion of the bike.

### CROSS-REFERENCE TO RELATED APPLICATIONS

This Application is the U.S. national phase of, and claims priority to, International Application No. PCT/EP2017/083931, filed Dec. 20, 2017, which designated the U.S. and which claims priority to EP Patent No. EP 16205990.1, filed Dec. 21, 2016. These applications are each incorporated by reference herein in their entireties.

### TECHNICAL FIELD OF THE INVENTION

The present invention relates to a bike retaining device and a bike carrier comprising such a bike retaining device.

### BACKGROUND OF THE INVENTION

Bike carriers are often mounted on a vehicle in order to hold a bike in an upright position during transportation. Such bike carriers are used to facilitate the transportation of bikes from one location to another. Different types of bike carriers are available and they may be mounted on/at different parts on the vehicle, e.g. on the roof of the vehicle or at the rear end of the vehicle. There are types of bike carriers that require that the front wheel of the bike is dismounted before loading the bike to the bike carrier, but there are also bike carriers which do not require that.

The bike carriers which are suitable for mounting on the roof of a vehicle may often include an elongated base member which extends in the travel direction of the car and a bike retaining device attached to the elongated base member. The bike retaining device often has a hook or a claw which is used to hold and/or secure a frame portion of a bike during transportation. When in use, the wheels of the bike are placed on the elongated base section.

A problem with bike carriers of today is that the loading and securing of the bike in the bike carrier may be difficult. When loading and securing a bike to such a bike carrier the person performing the act needs to stabilize the bike sufficiently and simultaneously regulate the hook or claw of the bike retaining device in order to secure it. For example, the hook or claw may often need to be opened before loading and closed afterwards in order to secure a frame portion of the bike inside the hook or claw. Often the loading and securing requires more than one person. Further, the loading and securing of a bike to such a bike carrier gets even more tricky if the person performing this act is not tall enough or does not have the required strength to stabilize the bike. Hence, there is a need to develop a new bike retaining device and a new bike carrier in order to improve the current state of the art. Such a bike retaining device and such a bike carrier is provided according to the present invention.

### SUMMARY OF THE INVENTION

It is one object of the invention to improve the current state of the art and to mitigate at least some of the above mentioned problems. These and other objects are achieved by a bike retaining device and a bike carrier, as defined in the accompanying independent claims.

According to a first aspect of the invention a bike retaining device for retaining a bike in a bike carrier arrangement on a vehicle is provided. The bike retaining device includes:

an elongated arm having a longitudinal extension;

a first portion and a second portion projecting laterally away from the elongated arm; and

a hook connected to the first portion, the hook having a first shank and a second shank.

The hook is arrangeable at least in a first configuration and a second configuration. In the first configuration the first shank is arranged such that a distance between the first portion and the second portion is at least partially covered by the first shank and such that it allows a user of the bike retaining device to press a frame portion of the bike against the first shank. The hook is movable from the first configuration to the second configuration when the user of the bike retaining device presses a frame portion of the bike against the first shank.

In the second configuration the second shank is arranged such that the distance between the first and second portion is at least partially covered by the second shank, whereby a space is defined by the first portion, the second portion and the second shank for securing the frame portion of the bike.

With this arrangement a bike can more easily be loaded in the bike carrier arrangement than what has been possible for the bike carriers earlier presented. The bike retaining device as provided by the invention has a “third hand”-function which facilitates the loading of the bike in the bike carrier since the person loading the bike may hold the bike with both his or her hands since there is no need for closing the bike retaining device with one of them. Hence, the bike retaining device according the invention does not require the same strength for balancing the bike with one hand. In other words, since the hook is arranged such that it is movable from the first configuration to the second configuration by pressing a frame portion of a bike towards the first shank there is no need for opening or closing the bike receiving device by hand.

It shall be understood that the longitudinal extension or direction of the elongated arm is the direction in which the elongated arm has its longest extension. Thus, the longest or main direction of the extension of the first and second portion is laterally relative to the longitudinal extension of the arm. It shall further be understood that by projecting laterally away from the elongated arm means that the longest extension of the first and second portion has a substantially different direction than the longest extension of the elongated arm. For example, according to at least one example embodiment of the invention the first and second portion may be projecting away from the elongated arm in a direction that is perpendicular to the longitudinal direction of the elongated arm. Moreover, it shall be understood that the distance between the first and the second portion is the distance between a distal end of the first portion and a distal end of the second portion. The distal end is referring to the end of the respective portion that is most far away from the elongated arm. Hence, a proximal end of the first or second portion is referring to the end which is arranged closest to the elongated arm.

According to at least one example embodiment of the invention the elongated arm may be made from a stiff material, such that the arm does not bend when loading the bike. Such a stiff material may for example be a metal, e.g. stainless steel or aluminum, or it can be a plastic material.

According to at least one example embodiment of the invention the first and second portion, as well as the hook may incorporate a stiff material such as a metal, e.g. stainless steel or aluminum, or it can be a plastic material. The first and second portion and the hook may include the same material or they may include different materials.

According to at least one example embodiment of the invention the first shank has a bike receiving surface. In order to move the hook from the first configuration to the second configuration the user first places the frame portion of the bike adjacent to this bike receiving surface and then subsequently presses the bike against this surface such that the hook is moved from its first configuration to its second configuration. Hence, there is no need for the user to move the hook between the configuration by using one of his or her hands.

According to at least one example embodiment of the invention, the first portion may be arranged above the second portion when the longitudinal extension of the elongated arm is vertical or substantially vertical. According to at least another example embodiment of the invention the second portion may be arranged above the first portion when the longitudinal direction of the elongated arm is vertical or substantially vertical.

According to at least one example embodiment of the invention the first and/or the second portion of the bike retaining device may include a bike resting surface. This is the surface where a part of the frame portion of the bike which has been secured in the bike retaining device will rest on during transportation. The bike resting surface of the first and/or the second portion is a surface facing the other portion. This surface may have a soft material which may be the same or a different soft material as comprised by the bike receiving surface.

According to at least one example embodiment of the invention the material of the bike receiving surface is different from the rest of the hook. For example, the bike receiving surface may include a soft material. The soft material may not destroy or make a mark in the frame portion of the bike which is placed adjacent and pressed against this surface. According to at least one example embodiment the bike receiving surface may be a bike resting surface. In other words, a bike which is loaded or secured in the bike retaining device may during transportation rest on the first shank.

According to at least one example embodiment of the invention the bike resting surface may be a non-planar surface. For example, it may be u-shaped or it may be v-shaped when looking at the bike retaining device across the main direction of the first and second portions. The non-planar shape of the bike resting surface hinders the bike to move away from the bike resting surface during transportation.

According to at least one example embodiment of the invention the first portion has a front side and back side. The front and back side of the first portion is spaced apart such that an empty space is defined in between. Hence, the first part may hollow. According to at least one example embodiment of the invention the hook is arranged between the front side and the back side of the first portion.

According to at least one example embodiment of the invention the first and the second shank may be of the same length. The length is such that the first shank at least partially covers the distance between the first and second portion in the first configuration and the second shank at least partially covers the distance between the first and the second portion in the second configuration. According to at least another embodiment of the invention the first and the second shank may be of different length. Also here the length is such that the first shank at least partially covers the distance between the first and second portion in the first configuration and the second shank at least partially covers the distance between the first and the second portion in the second configuration. For example, the first shank may be shorter than the second shank or vice versa.

According to at least one example embodiment of the present invention the first shank may cover at least 20% of the distance between the first and second portion, or at least 40% of the distance between the first and second portion, or at least 60% of the distance between the first and second portion, or at least 80% of the distance between the first and second portion, or it will fully cover the distance between the first and second portion when the hook is arranged in the first configuration.

According to at least one example embodiment of the present invention the second shank may cover at least 20% of the distance between the first and second portion, or at least 40% of the distance between the first and second portion, or at least 60% of the distance between the first and second portion, or at least 80% of the distance between the first and second portion, or it will fully cover the distance between the first and second portion when the hook is arranged in the second configuration.

According to at least one example embodiment of the invention the first shank may be longer than the distance of the first and the second portion. In such an embodiment the second portion may suitably be provided with a groove through which the first shank may move when the hook is moved from its first configuration to its second configuration.

According to at least one example embodiment of the invention the second shank may be longer than the distance between the first and the second portion.

According to at least one example embodiment of the invention the first portion and the second portion are arranged at a distance from each other and the first portion is movable relative the second portion in the direction of the longitudinal extension of the elongated arm.

Hereby, the distance between the first portions and the second portion can be altered. Thus, bikes with the bike retaining device can be adapted to hold bikes with different frame dimensions. Moreover, the distance between the first portion and the second portion can be altered such that it is different in the first configuration and the second configuration. Hereby, the distance between the first portion and the second portion can be adapted based on different needs, e.g. when the hook is arranged in the first configuration and the second configuration, respectively. More specifically, and for example, by providing the possibility to alter the distance between the first portion and the second portion, installation of the frame portion into the space by moving the first shank from the first configuration of the hook to the second configuration of the hook is facilitated, while also hindrance of the frame portion to leave the space by the second shank in the second configuration is enabled. For example, the extension of the first shank from the first portion towards the second portion in the first configuration may be adapted to partially cover the distance between the first portion and the second portion, thereby enabling the first shank to easily move such that the hook is moved from its first configuration to its second configuration. And the extension of the second shank from the first portion towards the second portion in the second configuration may be adapted to fully cover the distance between the first portion and the second portion, to hinder the frame portion of the bike to leave the space. Hereby, pressing of a frame portion of the bike against the first shank in order to secure the frame portion in the bike retaining device in the first configuration is facilitated, while still enabling a satisfactory securement of the frame portion in the space in the second configuration.

In other words, with the possibility to alter the distance between the first portion and the second portion, a minimal distance can be applied between the first portion and the second portion when the bike is transported, which thus leads to a better secured bike during transportation. Correspondingly, during loading of the bike, and hence application of the frame portion to the hook, a maximal distance between the first portion and the second portion can be applied, making the loading procedure of the bike easier and less comprehensive.

According to at least one example embodiment of the invention the first portion may be movable relative to the elongated arm. In other words, the first portion may be mounted to the elongated arm in such manner that it can be moved along the arm in its longitudinal direction.

According to at least one example embodiment of the invention the second portion may be fixedly mounted to the elongated arm and hence it cannot be moved along the elongated arm. Neither can it be moved relative the first portion.

According to at least one alternative example embodiment of the invention the second portion may be movable relative to the elongated arm. In other words, the second portion may be mounted to the elongated arm in such manner that it can be moved along the arm in its longitudinal direction.

According to at least one alternative example embodiment of the invention the first portion may be fixedly mounted to the elongated arm and hence it cannot be moved along the elongated arm. Neither can it be moved relative the second portion.

According to at least one alternative example embodiment of the invention the first portion may be movable relative to the elongated arm. In other words, the first portion may be mounted to the elongated arm in such manner that it can be moved along the elongated arm in its longitudinal direction.

Additionality or alternatively, the second portion may be movable relative to the elongated arm. In other words, the second portion may be mounted to the elongated arm in such manner that it can be moved along the elongated arm in its longitudinal direction.

According to at least one example embodiment the first portion may include an opening at a proximal end arranged such that the elongated arm is provided inside this opening. The opening may be for example ring-formed or rectangular or it may be an irregular shape. The opening may be provided such that the first portion may slide along the elongated arm while moving relative the second portion. According to at least one example embodiment of the invention the elongated arm may have a cross-section which corresponds to the shape of the opening.

According to at least one example embodiment of the invention the first shank and the second shank are arranged at an angle, e.g. perpendicular, to each other. Having the first and second shank perpendicular to each other means that the space defined by the first and second portion and the second shank will be substantially rectangular formed when the hook is arranged in the second configuration without having the first shank extending into that space. It shall be understood that it is the main direction of the first and second portion and the second shank which gives the space its substantially rectangular space.

According to at least one example embodiment of the invention the hook is pivotably attached to the first portion such that the first and second shank pivot simultaneously around a pivot point. By having the hook pivotably attached to the first portion it is easy to move the hook from its first configuration to its second configuration by pressing the frame portion of the bike against the first shank of the hook.

According to at least one example embodiment of the invention the hook is pivotably attached to the first portion via connection means, which connection means being for example a pin which goes through connection holes in both the first portion and the hook. The connection holes of the first portion and the hook will be aligned such that the pin can go through these connection holes. According to at least one example embodiment of the invention the front and the back side of the first portion has a connection hole each which are being aligned with the connection hole of the hook such that the pin can go through the hole of both the front and back side of the first portion and the hook. Hence, the hook is pivotably attached to both the front and back side of the first portions.

Although the above described pivotable connection of the hook to the first portion is advantageous, other connections are conceivable. For instance, according to at least one example embodiment of the invention, the first and the second shank may be parallel in a fork-like configuration and the hook may be connected to the first portion such that the hook can be pushed or dragged along a track or a groove in the first portion when moving from the first configuration to the second configuration such that the first shank at least partially covers the distance between the first and the second portion in the first configuration and such that the second shank at least partially covers the distance between the first and the second portion in the second configuration.

According to at least one example embodiment of the invention the hook is attached to the first portion at a distal end of the first portion. This facilitates the loading of the bike to the bike retaining device since this shortens the distance to be reached, i.e. the first shank will be closer to the person loading the bike to the bike retaining device.

According to at least one example embodiment of the invention, in the first configuration the first shank is substantially parallel to the longitudinal extension of the elongated arm and the second shank is substantially parallel to a projecting direction of the first and second portions. In the second configuration the first shank is substantially parallel to the projecting direction of the first and second portions and the second shank is substantially parallel to the longitudinal extension of the elongated arm. Hence, if the first and the second shank is arranged perpendicular to each other the hook may pivot 90 degrees between the first and the second configuration.

According to at least one example embodiment of the invention the hook is connected to the first portion via a spring, and the hook is under spring load in at least one of the first configuration or the second configuration. It shall be understood that under spring load means that the spring will apply a force on the hook, which force would cause a movement of the hook if the hook would not be physically hindered to move in the direction of the force.

According to at least one example embodiment of the invention the first portion has at least one stop or edge arranged for keeping the hook in the first or the second configuration while the spring strive towards its normal, non-compressed state. The spring “strives” towards its normal state, i.e. a state where the spring is at rest, and if the spring were allowed to extend to such a state the hook would pivot further. This movement is hindered by the at least one stop or edge.

According to at least one example embodiment the bike retaining device includes two springs. The springs may be arranged such that one of the springs applies a force on the hook, and thus press the hook against a stop or an edge, i.e. keeping the hook under spring load, when in the first configuration, and the other one applies a force on the hook, and thus press the hook against a stop or an edge, i.e. keeping the hook under spring load, when in the second configuration.

According to at least one example embodiment of the invention the hook includes a first and a second attachment point. The first attachment point is the pivot point and the spring is connected to the hook at the second attachment point. The first and the second attachment points are spaced apart on the hook.

According to at least one example embodiment of the invention the spring is attached to the hook by connection means, which connection means are attached in a point, e.g. a hole, in the hook which has a different location as compared to where the hook is pivotably attached to the first portion.

According to at least one example embodiment of the invention the spring is connected to a point on the hook where the first and the second shank meet.

According to at least one example embodiment of the invention the spring is compressed when pivoting the hook from the first configuration to the second configuration.

When the spring is in the first or the second configuration the spring may be less compressed as compared with any location between the first and second configuration. When moving the hook from the first to the second configuration or vice versa, the spring may be gradually compressed until a center point between the first and the second configuration is reached. After that center point is reached the spring will be extended gradually until either the first or second configuration is reached. The hook is not able to move from the first configuration towards the second configuration by itself since a force has to be applied to the first shank in order to compress the spring. Hence, the hook will stay in the first configuration and there is no need for a user loading a bike to the bike retaining device to hold the hook by hand while loading the bike. Moreover, the hook is not able to move from the second configuration towards the first configuration by itself since a force has to be applied to the second shank in order to compress the spring. The bike may therefore be secured in the bike retaining device during transportation. Applying a force to either the first or second shank in order to move the hook from the first configuration towards the second configuration or vice versa may be done by pressing a frame portion against the first or second shank.

According to at least one example embodiment of the invention the longitudinal extension of the spring will change direction while moving the hook from the first to the second configuration or vice versa. Viewing the spring along its longitudinal extension from the first portion towards the hook, the spring will point towards the elongated arm while the hook is in the first configuration. When the hook is in the second configuration the spring will point away from the elongated arm. As the spring is being most compressed the direction of the longitudinal extension of the spring will substantially be parallel to the elongated arm. In other words, the angle between the longitudinal extension of the spring and the main direction of the first portion will change when the hook moves from its first to its second configuration or vice versa.

According to at least one example embodiment of the invention the second shank of the hook substantially covers the full distance between the first portion and the second portion in the second configuration at least when the distance between the first portion and the second portion is equal to a minimal distance between the first portion and the second portion. The second shank will therefore hinder the frame portion of the bike to leave the space defined by the first and second portion and the second shank.

According to at least one example embodiment of the invention the distance between the first and the second portion may be defined by a track arranged on the elongated arm. For example, a part, e.g. a protruding part, of the first portion may move along or inside the track when the first portion moves relative the second portion. The minimal and maximal distance between the first and the second portion may then be defined by the length of the track since the part of the first portion is hindered to move a further distance than the distance of the track.

According to at least one example embodiment the distance between the first and the second portion may be defined by one or two stops arranged on the elongated arm. The first portion may move along the elongated arm and relative the second portion until a stop is reached.

According to at least one example embodiment of the invention the minimal distance between the first and the second portion may be defined by the width of the frame of the bike which has been secured in the bike retaining device. In such an embodiment the first portion can move towards the second portion until it or the hook reaches the frame of the bike. Hence, both the first portion or the hook and the second portion will be in contact with the frame of the bike. The minimal distance between the first and the second portion will therefore be different when bikes of different size, i.e. different frame dimensions, are loaded in the bike retaining device.

According to at least one example embodiment of the invention the elongated arm has a first and a second part. The first part is movable in the longitudinal direction of the elongated arm relative the second part, and the first portion is arranged on the first part of the elongated arm and the second portion is arranged on the second part of the elongated arm.

According to at least one example embodiment of the invention the first portion may be fixedly connected to the first part of the elongated arm and does not move along the first part. The first portion will be movable relative the second portion just by moving the first part relative the second part of the elongated arm.

According to at least one example embodiment of the invention one of the first or second parts of the elongated arm is telescopically movable relative the other.

According to at least one example embodiment of the invention the first part of the elongated part may be partly arranged inside the second part of the elongated arm. The first part may then move inside of the second part, i.e. the first part is telescopically movable relative to the second part. According to at least another embodiment of the invention the second part of the elongated arm may be partly arranged inside the first part. The first part may then move along the second part on the outside of the second part.

According to at least one example embodiment of the invention, the bike retaining device further includes an elongated member arranged inside or along the elongated arm. The elongated member is arranged for moving the first portion relative to the second portion. The elongated member may facilitate the movement of the first portion relative to the second portion since the person loading and securing the bike in the bike retaining device may not need to reach for the first portion in order to move this portion relative to the second portion.

According to at least one example embodiment of the invention the elongated member may be a stiff member. For example, it may be a stick or a rod of e.g., metal or a plastic material. According to at least another example embodiment of the invention the elongated member may be a flexible member. For example, it may be a strand or a cord of e.g. textile or plastic. Further, such a flexible member may also be a metal chain or a flexible metal wire.

According to a second aspect of the invention a bike carrier is provided. The bike carrier includes a bike retaining device and a base member wherein the bike retaining device is attached to the base member.

Effects and features of this second aspect of the present invention are largely analogous to those described above in connection with the first aspect of the inventive concept. Embodiments mentioned in relation to the first aspect of the present invention are largely compatible with the second aspect of the invention.

According to at least one example embodiment of the invention the base member is an elongated member which is mountable such that the longest extension of the base member is in the travel direction of the vehicle to which the bike carrier is mounted.

According to at least one example embodiment of the invention the base member includes a first and a second wheel holder arranged such that they are separated from each other on the base member. The wheel holders may hinder the bike to move away from the base member during transportation and hence the wheel holders may further stabilize the bike in the bike carrier arrangement.

According to at least one example embodiment the wheel holder may hinder the bike to move in a direction which is transverse of the travel direction of the vehicle to which the bike carrier is mounted.

According to at least one example embodiment of the invention the bike retaining device may be connected to the base member in proximity to the wheel holder which during use should hold the front wheel of the bike loaded in the bike carrier. According to at least another embodiment of the invention the bike retaining device is connected to the base member in proximity to the wheel holder which during use should hold the back wheel of the bike. According to at least yet another embodiment of the invention the bike retaining device is connected to the base member between the wheel holders.

According to at least one example embodiment of the invention the elongated member includes a first and a second end. The first end is connected to the first portion of the bike retaining device, and the second end is connected to the base member. The base member will be the lowest point of the bike carrier and therefore by having the elongated member connected to the base member, the elongated member may be connected to the point on the bike carrier that will be easiest for a user to reach if the bike carrier is mounted on the roof of the vehicle.

According to at least one example embodiment of the invention the connection of the elongated member to the base member secures the distance between the first and the second configuration. The elongated member may be connected to the base member such that the minimal distance between the first and the second configuration is kept during transportation of a bike. Hence, the elongated member is connected to the base member such that the bike may be secured by the second shank of the hook in the space defined by the first and the second portion and the second shank.

### BRIEF DESCRIPTION OF THE DRAWINGS

The above objects, as well as additional objects, features and advantages of the present invention, will be more fully appreciated by reference to the following illustrative and non-limiting detailed description of embodiments of the present invention, when taken in conjunction with the accompanying drawings, wherein:

FIG. 1 shows a semi-exploded, schematic view of a bike retaining device in accordance with at least one embodiment of the invention;

FIG. 2 shows a schematic view of the bike retaining device of FIG. 1 wherein the hook is in a first configuration;

FIG. 3 shows a schematic view of the bike retaining device of FIGS. 1-2 wherein the hook is in a second configuration;

FIG. 4 shows a schematic view of the bike retaining device of FIGS. 1-3 wherein the hook is in a position in between the first and the second configuration;

FIG. 5 shows a schematic view of a bike carrier comprising the bike retaining device of FIGS. 1-4 in accordance with at least one embodiment of the invention;

FIG. 6 shows a schematic view of the bike carrier of FIG. 5 when in use and wherein the hook is in a first configuration;

FIG. 7 shows a schematic view of the bike carrier of FIG. 5-6 when in use and wherein the hook is in a second configuration.

### DETAILED DESCRIPTION OF THE DRAWINGS

In the present detailed description, embodiments of the present invention will be discussed with the accompanying figures. It should be noted that this by no means limits the scope of the invention, which is also applicable in other circumstances for instance with other types or variants of bike retaining devices and bike carriers than the embodiments shown in the appended drawings. Further, that specific features are mentioned in connection to an embodiment of the invention does not mean that those components cannot be used to an advantage together with other embodiments of the invention.

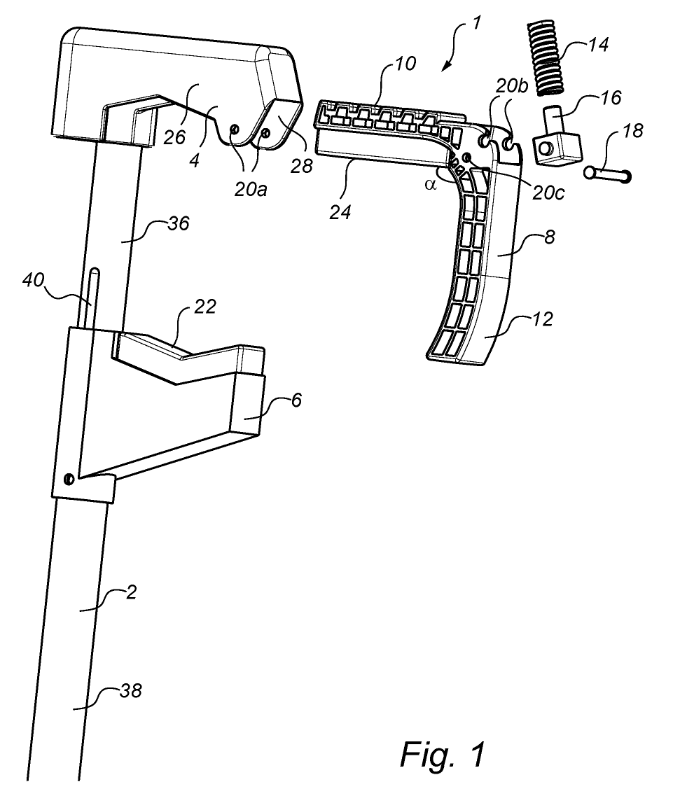

FIG. 1 shows an exploded view of a bike retaining device 1. The bike retaining device 1 includes an elongated arm 2 having a longitudinal extension, a first portion 4 and a second portion 6. The first portion has connection holes 20a and a front side 26 and a back side 28. The second portion 6 has a bike resting surface 22. Moreover, the bike retaining device 1 includes a hook 8, which has a first 10 and a second shank 12 and first connection holes 20b and a second connection hole 20c. The first shank 10 has a bike receiving surface 24. The bike retaining device 1 of FIG. 1 further includes a spring 14 and a first 16 and second connection means 18. The elongated arm has a first 36 and a second part 38. Further, the first part 36 of the elongated arm 2 includes a track 40.

The first 4 and second portions 6 are arranged such that they project laterally away from the elongated arm 2. The first 10 and second shank 12 are arranged at an angle a to each other. Here, the angle between the main extension of the first 10 and the second shank 12 is substantially 90 degrees, hence the first 10 and the second shank 12 is arranged perpendicular to each other.

The bike resting surface 22 is a non-planar surface, it may be substantially cup-shaped. Here, it is v-shaped. The non-planar shape of the bike resting surface 22 hinders the bike to move away from the bike resting surface 22 when the bike retaining device 1 is in use. The bike resting surface 22 is arranged such that it is facing the first portion 4.

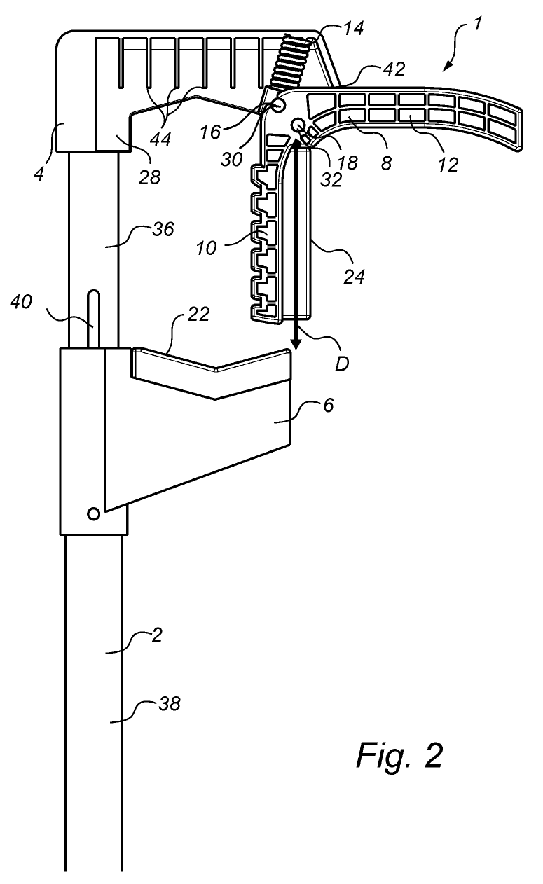

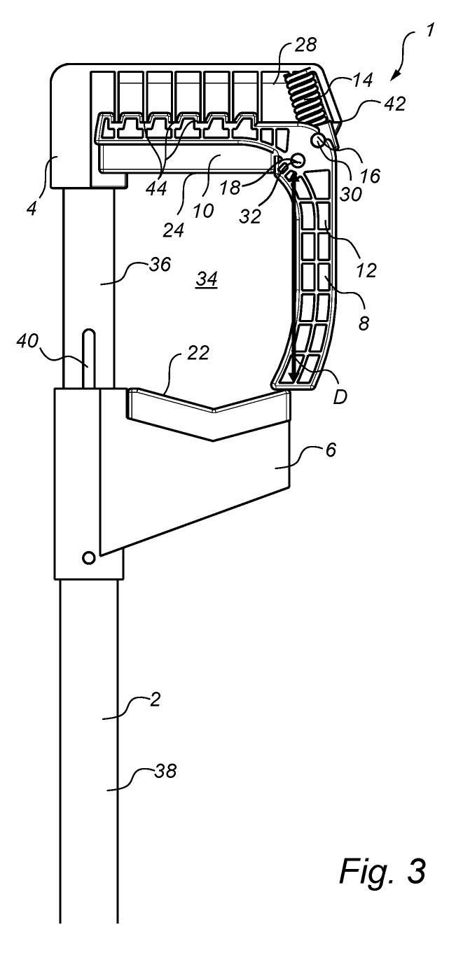

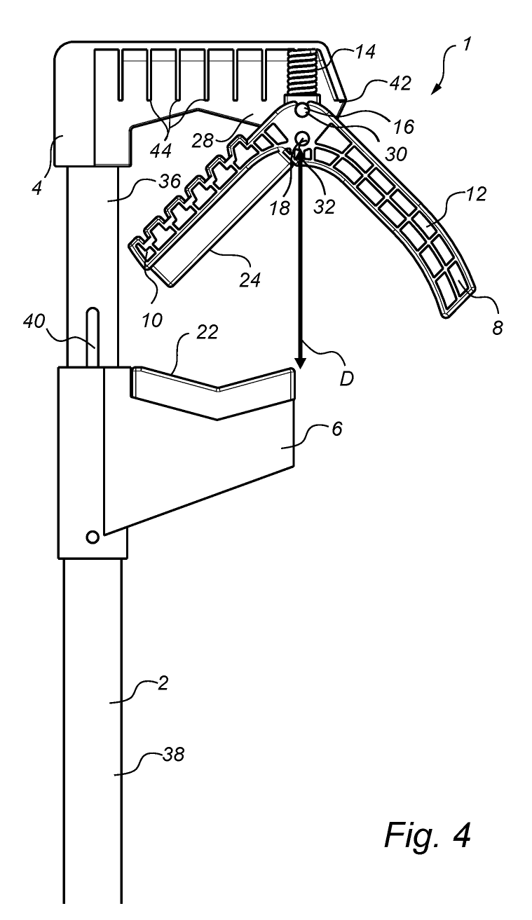

Now turning to FIGS. 2-4, which figures show the bike retaining device 1 in FIG. 1. These figures show the hook 8 of bike retaining device 1 is in a first configuration (FIG. 2) and a second configuration (FIG. 3) or in between the first and the second configuration (FIG. 4). The front side 26 of the first portion 4 is not shown in these figures to facilitate the description and to clearer visualize how the hook 8 is connected to the first portion 4. The hook 8 is arranged in between the front side 26 and the back side 28 of the first portion 4. Moreover, the hook 8 is arranged such that the connection hole 20c of the hook 8 and the connection holes 20a of the first portion 4 is aligned. It can be seen in FIGS. 2-4 here that the backside 28 further has an edge 42 arranged at the distal end of the first portion 4 and stops 44. The edge 42 is arranged such that the hook is kept under spring load in its first configuration. The stops 44 are arranged such that the hook is kept under spring load when it is in its second configuration.

The length of the elongated arm 2 may be varied such that the distance between the first 4 and second portions 6 is altered. For instance, the distance between the first 4 and the second portion 6 shall preferably be a minimal distance during transportation of a bike. Further, the distance shall preferably be a maximal distance during loading of a bike in the bike retaining device 1. The first part 36 is arranged inside the second part 38 of the elongated arm 2. Here, the length of the elongated arm 2 can be altered between a maximal and a minimal distance by moving the first part 36 relative the second part 38 along track 40. The first part 36 may move inside the second part 38, i.e. the first part 36 is telescopically movable relative the second part 38. The ends of the track 40 define the maximal and minimal distance between the first 4 and second portions 6. Not visible in the figure there is a protruding part inside the second part 38 of the elongated arm 2 which moves inside the track 40.

The hook 8 is connected to the first portion 4 via a first 30 and a second attachment point 32. The first attachment point 30 is where the first connection means 16 is attached to the hook 8. The first connection means 16 is further connected to the spring 14 which is attached to the first portion 4 of the bike retaining device. The first connection means 16 is attached to the hook 8 via the first connection hole 20b. The second attachment point 32 is where the second connection means 18 is attached to the hook 8. The second connection means 18 goes through the connection holes 20a of the first portion 4 as well as the second connection hole 20c of the hook 8. The second attachment point 32 is a pivot point for the hook 8 which enables the movement of the hook 8 from its first configuration to its second configuration. The first and the second attachment points 30, 32 are spaced apart on the hook 8.

FIG. 2 show the bike retaining device 1 when the hook is arranged in the first configuration. When in the first configuration, the first shank 10 is arranged such that the distance D between the first 4 and the second portion 6 is partially covered. The first shank 10 is parallel to the longitudinal direction of the elongated arm 2. The second shank 12 is here substantially parallel to a projecting direction of the first 4 and second portion 6. Moreover, the bike receiving surface 24 of the first shank 10 is arranged such that it allows a user of the bike retaining device 1 to put a frame portion of a bike adjacent to the bike receiving surface 24 and further allows the user to press a frame portion of the bike against the bike receiving surface 24 of the first shank 10. When the user presses the frame portion towards the bike receiving surface 24 the hook 8 will move from the first configuration towards the second configuration.

In this first configuration the hook 8 is under spring load. The spring 14 “strives” towards its normal state, i.e. towards the elongated arm 2, which may cause a movement of the hook such that the second shank 12 moves upwards as depicted in the figure. The edge 42 is arranged on the first portion such that there are no possibilities for this movement and the spring is kept compressed. The spring 14 applies a force on the hook 8 in a direction towards the elongated arm 2. In order to move the hook in the other direction, i.e. towards the second configuration, a force is required since the spring 14 needs to be more compressed. This force may be applied by pressing the frame portion of the bike against the bike receiving surface 24, i.e. against the first shank 10.

FIG. 3 shows the bike retaining device 1 when the hook 8 is arranged in the second configuration. When in the second configuration the second shank 12 is arranged such that the distance between the first 4 and second portion 6 is at least partially covered. Here, the length of the elongated arm 2 is set so that the distance between the first 4 and second portions 6 is minimal. The length of the second shank 12 equals this minimal distance between the first 4 and second portion 6 and hence the distance is fully covered by the second shank 12. When the hook 8 is arranged in the second configuration a space 34 is defined by the first portion 4, the second portion 6 and the second shank 12 for securing a frame portion of a bike.

In this second configuration the hook 8 is under spring load. The spring 14 “strives” towards its normal state, i.e. away from the elongated arm 2, which may cause a movement of the hook such that the first shank 10 moves upwards as depicted in the figure. The stops 44 are arranged on the first portion such that there are no possibilities for this movement and the spring is kept compressed. The spring 14 applies a force on the hook 8 in a direction away from the elongated arm 2. In order to move the hook in the other direction, i.e. towards the first configuration, a force is required since the spring 14 needs to be more compressed. This force may be applied by pressing the frame portion of the bike against the second shank 12, and thereby compress the spring. Please note the direction of the longitudinal extension of the spring 14 is different when the hook is arranged in the first configuration as depicted in FIG. 2 compared to when the hook is arranged in the second configuration as depicted in FIG. 3.

FIG. 4 shows the bike retaining device 1 when the hook 8 is in arranged between the first and the second configuration. When in between the first and second configuration, the hook 8 is not under spring load and the spring is here in a more compressed state as compared with when the hook 8 is arranged in its first or second configuration. The spring will “strive” to a more elongated state, i.e. its normal state, and hence there is a minimal force needed to move to either the first or the second configuration. Here, the hook 8 is in the middle between the first and the second configuration and the longitudinal extension of the spring 14 is parallel to the elongated arm 2. The spring 14 applies a downwardly directed force on the hook 8 and a movement of the hook 8 in that direction is hindered by the second connection means 18.

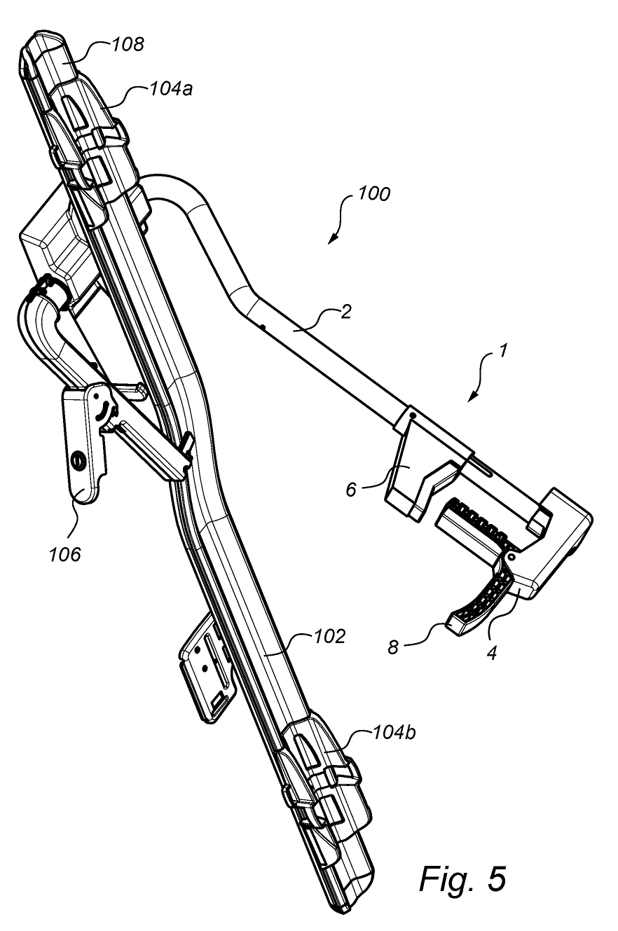

FIG. 5 shows a bike carrier 100 comprising the bike retaining device 1, which has previously been shown in FIGS. 1-4 above. Moreover, the bike carrier includes a base member 102. The base member 102 has two wheel holders 104a and 104b which are spaced apart on the base member 102 as well as a tensioning mechanism 106. In FIG. 5, the hook 8 of the bike retaining device is arranged in the first configuration. The bike retaining device 1 is connected to the base member 102 close to a front end 108 of the bike carrier 100. The tensioning mechanism 106 is connected to an elongated member (not shown in the figure). The elongated member is arranged for moving the first portion 4 relative the second portion 6. The tension mechanism 106 is arranged to pull the elongated member, which in turn pulls the first portion 4, such that the distance between the first 4 and the second portion 6 is decreased. When the tensioning mechanism 106 is in a locked configuration there are no possibilities for any movement of the first portion 4 relative the second portion 6 in the longitudinal extension of the elongated arm.

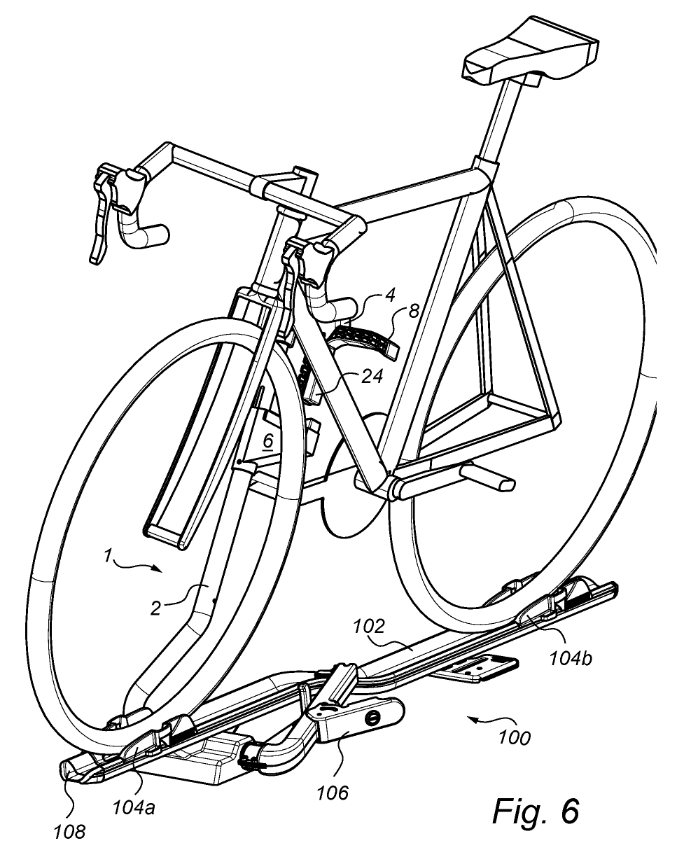

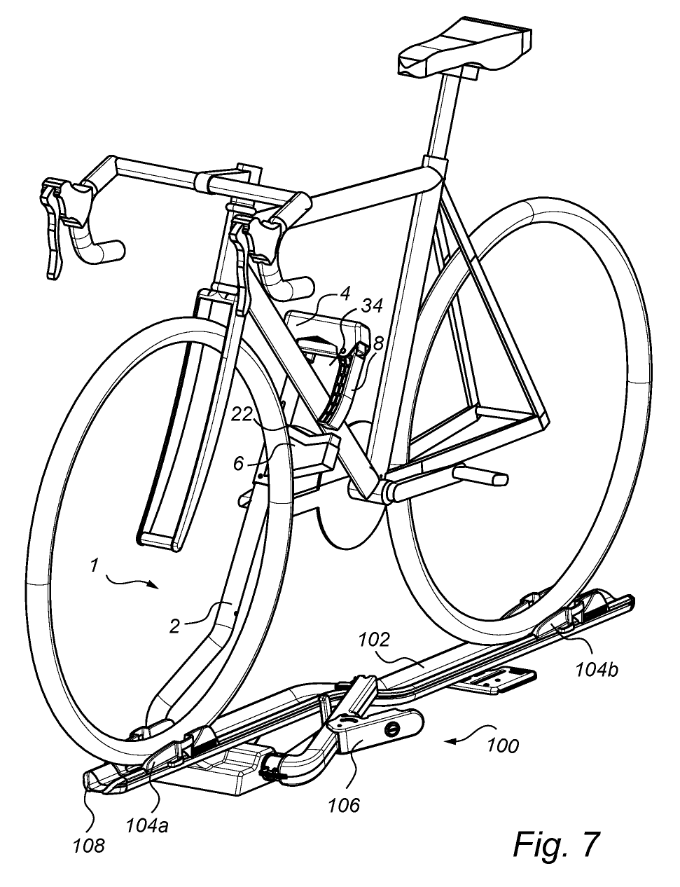

FIG. 6-7 show the bike carrier 100 when in use. In FIG. 6 the wheels of the bike have been placed in the wheel holders 104a,b. The hook 8 of the bike retaining device 1 is arranged in the first configuration. A frame portion of the bike is placed adjacent to the bike receiving surface 24, the frame portion may be pressed against the bike receiving surface 24 in order to move the hook 8 from the first configuration to the second configuration.

In FIG. 7 the hook 8 of the bike retaining device 1 is arranged in the second configuration. The frame portion of the bike is here secured in the space 34 defined by the first 4 and second portion 6 and the second shank 12. The frame portion rest on the bike resting surface 22 of the second portion 6.

The skilled person realizes that a number of modifications of the embodiments described herein are possible without departing from the scope of the invention, which is defined in the appended claims. For instance, the angle between the first and the second shanks may be less than 90 degrees. Furthermore, the length of the different parts of the bike retaining device may be of different length suitable for different types and sizes of the bike which may be secured in the bike retaining device.

1. A bike retaining device for retaining a bike in a bike carrier arrangement on a vehicle, said bike retaining device comprising:
an elongated arm having a longitudinal extension;
a first portion and a second portion projecting laterally away from said elongated arm;
a hook connected to said first portion, said hook comprising a first shank and a second shank;
said hook is arrangeable at least in a first configuration and a second configuration;
in said first configuration, said first shank is arranged such that a distance between said first portion and said second portion is at least partially covered by the first shank and such that a user of said bike retaining device can press a frame portion of said bike against said first shank;
said hook is movable from said first configuration to said second configuration when said user of said bike retaining device presses said frame portion of said bike against said first shank; and
in said second configuration, said second shank is arranged such that the distance between said first and second portion is at least partially covered by said second shank, whereby a space is defined by said first portion, said second portion, and said second shank for securing said frame portion of said bike.

2. The bike retaining device according to claim 1, wherein:
said first portion and said second portion are arranged at a distance from each other; and
said first portion is movable relative the second portion in the direction of the longitudinal extension of the elongated arm.

3. The bike retaining device according to claim 1, wherein said first shank and said second shank are arranged at an angle to each other.

4. The bike retaining device according to claim 1, wherein said hook is pivotably attached to said first portion such that said first and second shank pivot simultaneously around a pivot point.

5. The bike retaining device according to claim 1, wherein said hook is attached to said first portion at a distal end of said first portion.

6. The bike retaining device according to claim 1, wherein:
in said first configuration, said first shank is substantially parallel to said longitudinal extension of said elongated arm and said second shank is substantially parallel to a projecting direction of said first and second portions; and
in said second configuration, said first shank is substantially parallel to said projecting direction of said first and second portions and said second shank is substantially parallel to said longitudinal extension of said elongated arm.

7. The bike retaining device according to claim 1, wherein said hook is connected to said first portion via a spring, and wherein said hook is under spring load in at least one of said first configuration or said second configuration.

8. The bike retaining device according to claim 17, wherein:
said hook comprises a first and a second attachment point;
said first attachment point is said pivot point and said spring is connected to said hook at said second attachment point; and
said first and said second attachment points are spaced apart on said hook.

9. The bike retaining device according to claim 7, wherein said spring is compressed when pivoting said hook from said first configuration to said second configuration.

10. The bike retaining device according to claim 1, wherein said second shank of the hook substantially covers said full distance between said first portion and said second portion in said second configuration at least when said distance between said first portion and said second portion is equal to a minimal distance between said first portion and said second portion.

11. The bike retaining device according to claim 1, wherein:
said elongated arm comprises a first and a second part;
said first part is movable in the longitudinal extension of said elongated arm relative said second part; and
said first portion is arranged on said first part of the elongated arm and the second portion is arranged on said second part of the elongated arm.

12. A bike retaining device according to claim 1, wherein said bike retaining device further comprises an elongated member arranged inside or along said elongated arm; and wherein said elongated member is arranged for moving said first portion relative said second portion.

13. A bike carrier comprising:
a bike retaining device according to claim 1; and
a base member;
wherein said bike retaining device is attached to said base member.

14. The bike carrier arrangement according to claim 10, wherein said base member comprises a first and a second wheel holder arranged separated from each other on said base member.

15. The bike carrier arrangement according to claim 10, wherein:
said elongated member comprises a first and a second end;
said first end is connected to said first portion of said bike retaining device; and
said second end is connected to said base member.

16. The bike carrier arrangement according to claim 3, said first shank and said second shank are arranged perpendicular to each other.

17. The bike retaining device according to claim 4, wherein said hook is connected to said first portion via a spring, and wherein said hook is under spring load in at least one of said first configuration or said second configuration.

18. The bike retaining device according to claim 8, wherein said spring is compressed when pivoting said hook from said first configuration to said second configuration.

19. The bike carrier arrangement according to claim 11, wherein:
said elongated member comprises a first and a second end;
said first end is connected to said first portion of said bike retaining device; and
said second end is connected to said base member.

20. The bike retaining device according to claim 6, wherein said hook is connected to said first portion via a spring, and wherein said hook is under spring load in at least one of said first configuration or said second configuration.
